(19) United States
(12) Patent Application Publication
(10) Pub. No.: US 2011/0152130 A1
(43) Pub. Date: Jun. 23, 2011

(54) Dual Function Gas Hydrate Inhibitors

(75) Inventors: Hertanto Adidharma, Laramie, WY (US); Chongwei Xiao, Socorro (MX)

(73) Assignee: UNIVERSITY OF WYOMING, Laramie, WY (US)

(21) Appl. No.: 12/922,189

(22) PCT Filed: Mar. 12, 2009
(86) PCT No.: PCT/US09/36928

§ 371 Date: Feb. 7, 2011

Related U.S. Application Data
(60) Provisional application No. 61/035,836, filed on Mar. 12, 2008.

(51) Int. Cl. C09K 8/52

(52) U.S. Cl. 507/90

(57) ABSTRACT

The present invention involves inhibiting clathrate hydrate formation by adding ionic liquids that are soluble in water. Properly tailored ionic liquids shift the hydrate-aqueous liquid-vapor equilibrium curve to a lower temperature and, at the same time, retard the hydrate formation by slowing down the hydrate nucleation rate. This dual function makes this type of inhibitors perform more effectively. The present invention is useful for the production, processing, and transportation in oil and gas industry, especially for deep-sea exploration and production where the operating temperature and pressure become in favor of hydrate formation.

### BACKGROUND OF THE INVENTION

This application claims priority to U.S. Patent Application Ser. No. 61/035,836, filed Mar. 12, 2008, and incorporated herein in its entirety by this reference.

The invention relates generally to inhibiting the formation of gas hydrates using ionic liquids and, more specifically, to ionic liquids that function as both thermodynamic and kinetic inhibitors of hydrate formation.

The formation of gas hydrates in oil and gas industries have been the subject of long-standing problems. For example, the hydrate formation may occur and block gas pipelines, which can lead to safety hazards. It may also occur in the drilling fluids that are used in deep offshore drilling operations, resulting in severe threats towards the operation safety. All of these also lead to catastrophic economic losses and ecological risks.

Several inhibitors have been developed to inhibit the formation of hydrate. There are two types of inhibitors that are used nowadays: thermodynamic and kinetic inhibitors. These two inhibitors should be distinguished from hydrate anti-agglomerates, which prevent the hydrate crystals from agglomerating and accumulating into large masses. Thermodynamic inhibitors shift the equilibrium hydrate dissociation/stability curve, i.e., the hydrate-aqueous liquid-vapor equilibrium (HLVE) curve, to a lower temperature and thus avoid the hydrate formation. Methanol is such an inhibitor that is quite effective and widely used. However, since exploration and production moves to deeper seas, temperature and pressure conditions in the field become in favor of hydrate formation, i.e., the temperature is colder and the pressure is higher, and the addition of this type of inhibitor would be expensive and environmentally prohibitive; the inhibitor concentration required to prevent hydrate formation is very high, often in excess of 60 wt %. Sodium chloride is another example that has been used as thermodynamic inhibitor. However, adding inorganic salt also leads to corrosion problem. Kinetic inhibitors, on the other hand, do not prevent the hydrate formation at a certain condition, but retard the hydrate formation by slowing down the hydrate nucleation and growth rates. In the deep sea gas exploration, this type of inhibitor delays hydrate formation to a longer time than the residence time of the gas in the hydrate-prone section of pipeline. Polyvinylpyrrolidone (PVP) is an example of such an inhibitor. The existing kinetic inhibitors, however, are still not believed to give an economic solution especially at high pressure and large degree of supercooling. It has also been identified for some cases that the combination of thermodynamic and kinetic inhibitors is still needed to give better results. Therefore, there is still a need to discover inhibitors that are more effective than the existing inhibitors.

### SUMMARY OF THE INVENTION

The present invention inhibits clathrate hydrate formation by adding ionic liquids that are soluble in water. Properly tailored ionic liquids shift the HLVE curve to a lower temperature and, at the same time, retard the hydrate formation by slowing down the hydrate nucleation rate. This dual function makes this type of inhibitors perform more effectively. The present invention is useful for the production, processing, and transportation in oil and gas industry, especially for deep-sea exploration and production where the operating temperature and pressure favor hydrate formation.

### BRIEF DESCRIPTION OF THE FIGURES

FIG. 1 is a graph of the effectiveness of various thermodynamic inhibitors in shifting the hydrate dissociation temperature (HLVE curve) of methane hydrate.

FIG. 2 is a graph of the mean induction times of methane hydrate formation from blank samples and samples containing kinetic inhibitors at 106 bar and 25° C. supercooling.

FIG. 3 is a graph of the effect of EMIM-BF₄ concentration on induction time.

FIG. 4 is a chart of the effectiveness of EMIM-halides, BMIM-halides, and PMIM-I in shifting the hydrate dissociation temperature (HLVE curve) of methane hydrate; the effectiveness of EMIM-BF₄ and BMIM-BF₄ is also included for comparison.

FIG. 5 is a chart of the comparison of the mean induction times of methane hydrate formation from samples containing 1 wt % EMIM-BF₄, 1 wt % Luvicap®, and 1 wt % purified PVCap. For the same inhibitor weight fraction, EMIM-BF₄ outperforms both Luvicap and purified PVCap.

### DESCRIPTION OF THE INVENTION

Ionic liquids are liquid organic salts that have strong electrostatic charges and at the same time their anions and/or cations can be chosen or tailored to form hydrogen bonding with water. Besides these important properties, ionic liquids also offer several other desirable properties. For example, ionic liquids are environmentally friendly solvents due to their stability and extremely low vapor pressures. In addition, ionic liquids are very accessible, given their ease of preparation from relatively inexpensive materials. Common ionic liquids consist of bulky and asymmetric organic cations, such as imidazolium or pyridinium with alkyl chain substituents, and include 1-ethyl-3-methylimidazolium, 1-butyl-3-methylimidazolium and 1-pentyl-3-methylimidazolium. The common anions used include tetrafluoroborate (BF₄⁻), dicyanamide (N(CN)₂⁻), chloride, nitrate, iodide, and bromide.

Ionic liquids that are useful for this invention, due to their strong electrostatic charges and hydrogen bond with water, are able to act as both thermodynamic and kinetic inhibitors. This dual function makes this type of inhibitors perform more effectively. No previously known inhibitors offer both thermodynamic and kinetic inhibition effects.

### EXAMPLE 1

In this example, 1-ethyl-3-methylimidazolium tetrafluoroborate (EMIM-BF4) and 1-ethyl-3-methylimidazolium chloride (EMIM-Cl) were used to evaluate the performance of ionic liquids on inhibiting methane hydrate formation. The hydrate dissociation temperature and induction time for samples containing EMIM-BF4 and EMIM-Cl were measured using a high-pressure Micro Differential Scanning Calorimeter (HP μDSC). Induction time is an important indicator to characterize the kinetics of gas hydrate crystallization; the induction time is the time elapsing until the moment at which the onset of precipitation can be detected. The measurement of induction time were performed at a severe condition favoring hydrate formation, i.e., at 114 bar and 25° C. supercooling.

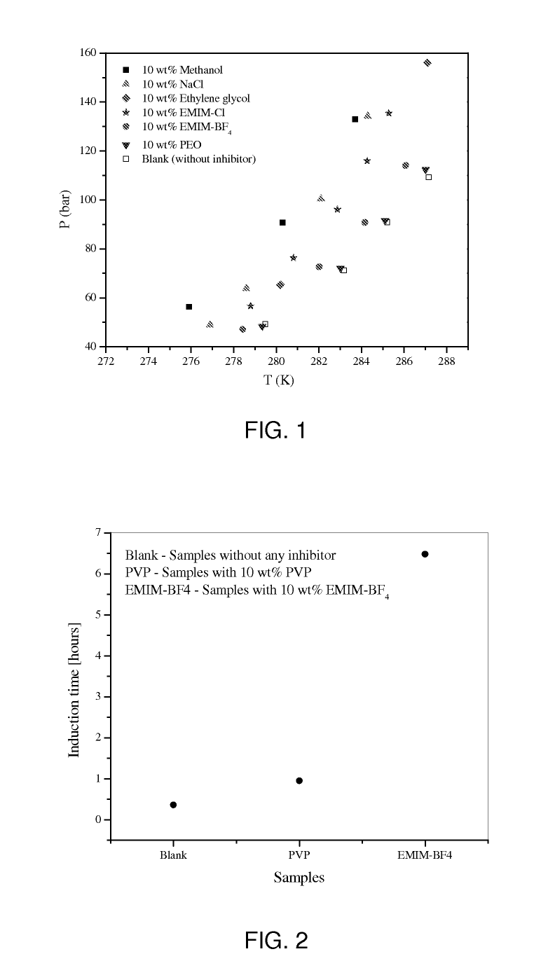

FIG. 1 shows the effectiveness of EMIM-BF₄ and EMIM-Cl as thermodynamic inhibitors compared to other existing thermodynamic inhibitors such as methanol, NaCl, ethylene glycol, and poly(ethylene oxide) (PEO). For the same concentration, the effectiveness of EMIM-Cl is as good as that of ethylene glycol, while the effectiveness of the other ionic liquid, i.e., EMIM-BF₄, is not as good as those of methanol, sodium chloride, and ethylene glycol. However, unlike the other existing thermodynamic inhibitors, ionic liquids also delay the formation of methane hydrate. Thus, these ionic liquids are thermodynamic and kinetic inhibitors.

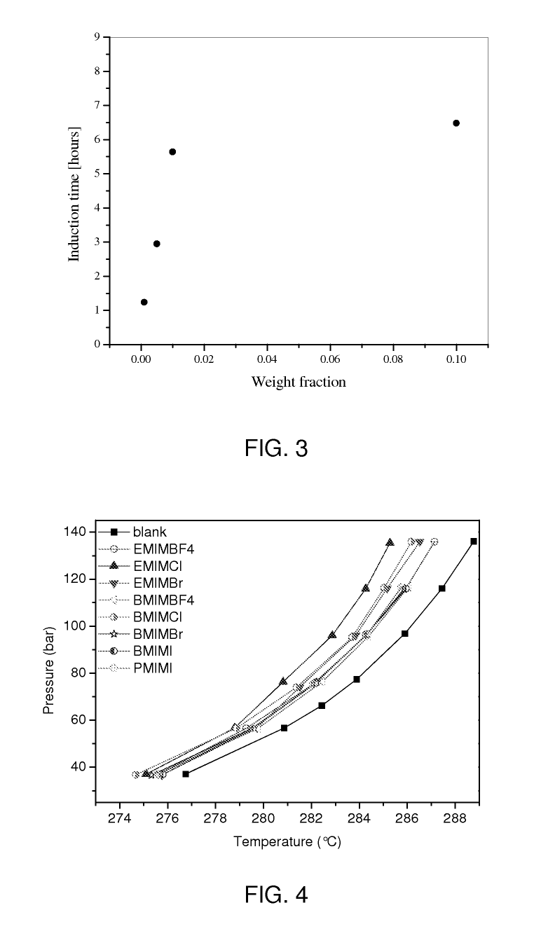

FIG. 2 shows the effectiveness of EMIM-BF₄ as a methane hydrate kinetic inhibitor compared to poly(N-vinyl pyrrolidone) (PVP), one of the existing kinetic inhibitors. For the same concentration, EMIM-BF₄ prolongs the induction time of methane hydrate formation much more than PVP does. Since kinetic inhibitors are usually used at low concentrations, say 1 wt % or lower, the performance of EMIM-BF₄ was also tested in the low concentration range. As shown in FIG. 3, even at a concentration of 0.5 wt %, the performance of EMIM-BF₄ is still far better than that of 10 wt % PVP. This type of inhibitors offers a significant improvement of kinetic inhibition effects over the existing kinetic inhibitors.

### EXAMPLE 2

The effectiveness of EMIM-halides, BMIM-halides (1-butyl-3-methylimidazolium-halides), and PMIM-I (1-pentyl-3-methylimidazolium iodide) as thermodynamic inhibitors were studied in the pressure range of 37 to 137 bar. The concentrations used were all 10 wt %. FIG. 4 shows the effectiveness of these inhibitors. Included in the figure are the effectiveness of EMIM-BF₄ and BMIM-BF₄, from Example 1. Among halides, chlorides are the best performers. Their performance is as good as that of ethylene glycol, one of the most widely used thermodynamics inhibitors. However, unlike the other existing thermodynamic inhibitors, these ionic liquids also delay the formation of methane hydrate. Thus, these ionic liquids function as both thermodynamic and kinetic inhibitors.

### EXAMPLE 3

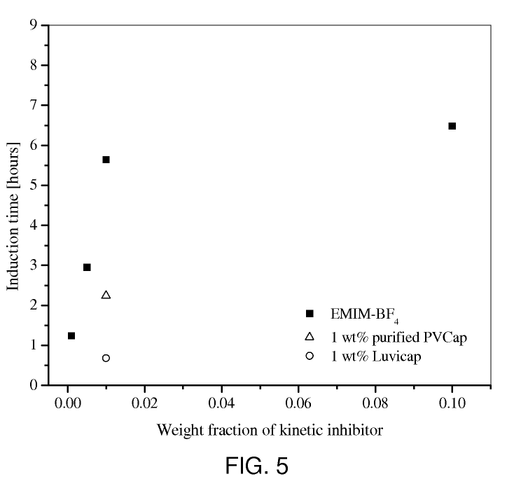

In Example 1, we compared the performance of EMIM-BF₄ with that of PVP, which has been widely used by academia as kinetic inhibitor reference. However, in industry, PVP is being replaced by poly(N-vinylcaprolactam) (PVCap) or Luvicap® (40 wt % PVCap in ethylene glycol; BASF), which are considered to be more effective in inhibiting the hydrate nucleation and/or growth rate. In this example, we measured the induction times of methane hydrate formation from a solution containing 1 wt % Luvicap® and from a solution containing 1 wt % purified PVCap. The measurement procedure was the same as that reported in Example 1. As shown in FIG. 5, the performance of EMIM-BF₄ was found to be much better than those of Luvicap® and purified PVCap.

The foregoing description and drawings comprise illustrative embodiments of the present invention. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

We claim:

1. A method of preventing clathrate hydrate formation in gases and oils, comprising adding an efficacious amount of ionic liquids that are soluble in water.

2. A method of shifting the hydrate-aqueous liquid-vapor equilibrium curve to a lower temperature of gases and oils, comprising adding an efficacious amount of ionic liquids that are soluble in water.

3. A method of retarding the hydrate formation in gases and oils by slowing down the hydrate nucleation rate, comprising adding an efficacious amount of ionic liquids that are soluble in water.

4. The method of any of claims 1-3, wherein the ionic liquid is selected from the group consisting of halide salts of 1-ethyl-3-methylimidazolium, 1-butyl-3-methylimidazolium and 1-pentyl-3-methylimidazolium, tetrafluoroborate salts of 1-ethyl-3-methylimidazolium, 1-butyl-3-methylimidazolium and 1-pentyl-3-methylimidazolium, and dicyanamide salts of 1-ethyl-3-methylimidazolium, 1-butyl-3-methylimidazolium and 1-pentyl-3-methylimidazolium.
